(19) United States
(12) Patent Application Publication
(10) Pub. No.: US 2012/0158758 A1
(43) Pub. Date: Jun. 21, 2012

(54) Comparison device and method for comparing test pattern files of a wafer tester

(75) Inventor: Fu-Tai CHEN, Hsinchu (TW)

(73) Assignee: King Yuan Electronics Co., Ltd., Hsinchu (TW)

(21) Appl. No.: 12/929,839

(22) Filed: Feb. 18, 2011

(30) Foreign Application Priority Data
Dec. 20, 2010 (TW) 099144726

(51) Int. Cl. G06F 17/30

(52) U.S. Cl. 707/758; 707/E17.039

(57) ABSTRACT

A comparison device for comparing test pattern files of a wafer tester includes a storage unit and a processing unit. The comparison device stores a first to-be-compared file and a second to-be-compared file into the storage unit. The first to-be-compared file and the second to-be-compared file are text files respectively. The processing unit reads the first to-be-compared file and the second to-be-compared file from the storage unit to process and executes comparison operation, so as to generate a comparison result. The comparison operation is to compare the words in a first section of the first to-be-compared file with the words in a second section of the second to-be-compared file in a one-to-one manner.

### BACKGROUND OF THE INVENTION

1. Field of the Invention

The present invention relates to the technical field of file comparison for wafer testing and, more particularly, to a comparison device and method for comparing test pattern files of a wafer tester.

2. Description of Related Art

Currently, for testing wafers, wafer manufacturers typically place a wafer under test inside a wafer tester and a corresponding test pattern file, which is built up according to the wafers under test, is inputted into the wafer tester for executing test procedure. Please refer to FIG. 1, which is a schematic diagram of inputting a test pattern file into a conventional wafer tester. As shown in FIG. 1, the test pattern file 10 is inputted into the wafer tester 1, and the wafer tester 1 generates corresponding analog test waveforms according to the test pattern file 10 for executing test procedure on a wafer under test.

Please refer to FIG. 2, which is a schematic diagram of a conventional test pattern file. The test pattern file 10 is a text file, the content of which is a large amount of words and the file size is greater than 1 GB. Since the test pattern file 10 is built up according the wafer under test, for manufacturers, the corresponding test pattern files should be built up according to different kinds of wafers with different sizes, patterns or functions for testing. In the prior art, a comparison software may be used if it is desired to compare the difference between different test pattern files to execute procedures, such as debugging. However, the comparison speed of the conventional comparison software is related to the file size, and thus the comparison speed may be decreased seriously if file size is too large. Since the file size of the test pattern file is quite large, there is no way to compare two files efficiently in the prior art. Accordingly, errors may occur easily and the time cost is high when comparing the content of files manually, and mistakes in the test pattern file may cause errors on testing, resulting in problems such as reworking, customer complaints, or even indemnity.

Therefore, it is desirable to provide a comparison device and method for comparing test pattern files of a wafer tester to mitigate and/or obviate the aforementioned problems.

### SUMMARY OF THE INVENTION

The object of the present invention is to provide a comparison device and method for comparing test pattern files of a wafer tester, which can compare the content of two test pattern files quickly.

According to one aspect, the present invention which achieves the object relates to a comparison device for comparing test pattern files of a wafer tester, which is provided for comparing a first to-be-compared file with a second to-be-compared file, wherein the first to-be-compared file and the second to-be-compared file are text files. The comparison device includes: a storage unit for storing the first to-be-compared file and the second to-be-compared file; and a processing unit for processing and executing comparison operation for the first to-be-compared file and the second to-be-compared file to generate a comparison result, the comparison operation comparing words in a first section of the first to-be-compared file with words in a second section of the second to-be-compared file in a one-to-one manner, wherein the first to-be-compared file and the second to-be-compared file are input into the comparison device; the comparison device stores the first to-be-compared file and the second to-be-compared file into the storage unit; the processing unit reads the first to-be-compared file and the second to-be-compared file from the storage unit, processes and executes comparison operation, and generates the comparison result.

According to another aspect, the present invention which achieves the object relates to a comparison method for comparing test pattern files of a wafer tester, which is used for comparing a first to-be-compared file with a second to-be-compared file by a computer device, the first to-be-compared file and the second to-be-compared file being text files, the computer device including a storage unit for storing files and a processing unit for processing and executing comparison operation to generate a comparison result, the comparison operation being to compare words in a first section of the first to-be-compared file with words in a second section of the second to-be-compared file. The comparison method includes the steps of: (A) inputting the first to-be-compared file and the second to-be-compared file into the comparison device; (B) the comparison device storing the first to-be-compared file and the second to-be-compared file into the storage unit; and (C) the processing unit reading the first to-be-compared file and the second to-be-compared file from the storage unit, processing and executing comparison operation, and generating the comparison result.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of inputting a test pattern file into a conventional wafer tester;

FIG. 2 is a schematic diagram of a conventional test pattern file;

FIG. 3 is a schematic diagram of the comparison device according to an embodiment of the present invention;

FIG. 4 is a flow chart of the comparison method according to an embodiment of the present invention;

FIG. 5A is a schematic diagram of the section score table according to an embodiment of the present invention;

FIG. 5B is a schematic diagram of the comparison result of the section score table according to an embodiment of the present invention;

FIG. 6A is a schematic diagram of the section score table according to another embodiment of the present invention;

FIG. 6B is a schematic diagram of the comparison result of the section score table according to another embodiment of the present invention;

FIG. 7A is a schematic diagram of setting up the to-be-compared sections in the two to-be-compared files according to an embodiment of the present invention;

FIG. 7B is a schematic diagram of the comparison result of the two to-be-compared sections according to an embodiment of the present invention; and

FIG. 7C is a schematic diagram of resetting the to-be-compared sections in the two to-be-compared files according to an embodiment of the present invention.

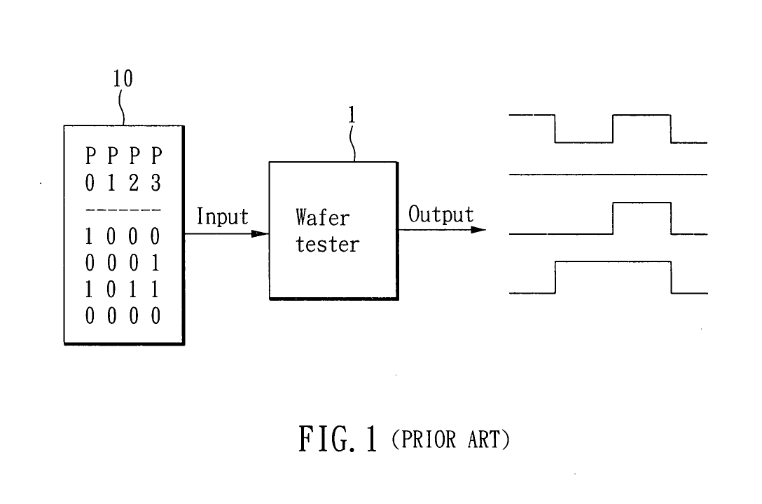

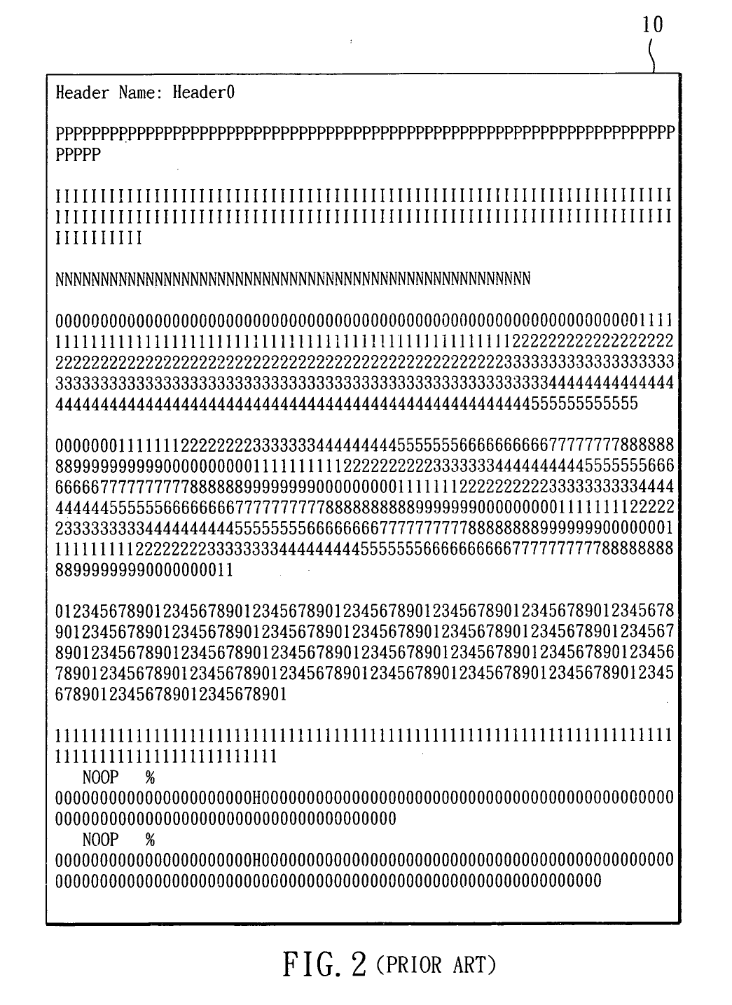

### DETAILED DESCRIPTION OF THE PREFERRED EMBODIMENT

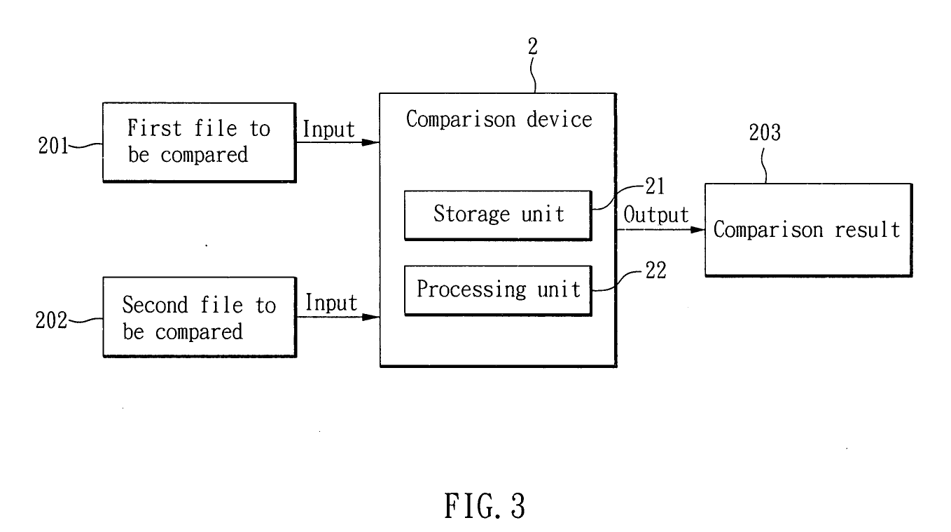

With reference to FIG. 3, there is shown a schematic diagram of the comparison device for comparing test pattern files of a wafer tester according to an embodiment of the present invention. As shown in FIG. 3, the comparison device 2 comprises a storage unit 21 and a processing unit 22, wherein the storage unit 21 is provided for storing a first to-be-compared file 201 and a second to-be-compared file 202 input by users, and the processing unit 22 is provided for processing and executing comparison operation for the first to-be-compared file 201 and the second to-be-compared file t 202, to thereby generate a comparison result 203. The comparison operation is to compare the words in a first section of the first to-be-compared file 201 with the words in a second section of the second to-be-compared file 202 in a one-to-one manner.

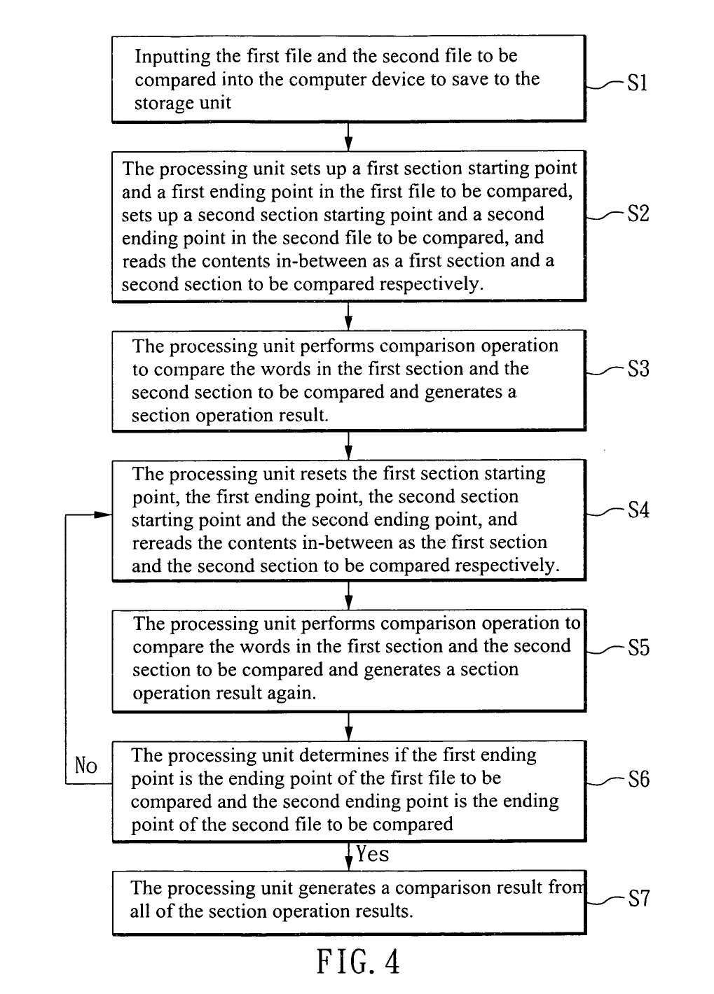

Please refer to FIG. 4, which is a flow chart of the comparison method for comparing test pattern files of a wafer tester according to an embodiment of the present invention. The comparison device 2 is preferably a computer device. When comparing files by the comparison device 2, the first to-be-compared file 201 and the second to-be-compared file 202 are first input into the comparison device 2, wherein the first to-be-compared file 201 and the second to-be-compared file 202 are text files and the file size of each of the first to-be-compared file 201 and the second to-be-compared file 202 can be greater than 1 GB. The comparison device 2 stores the first to-be-compared file 201 and the second to-be-compared file 202 into the storage unit 21 (step S1). The processing unit 22 sets up a first section starting point and a first section ending point in the first to-be-compared file 201, reads the content in-between the first section starting point and the first section ending point as a first to-be-compared section, sets up a second section starting point and a second section ending point in the second to-be-compared file 202, and reads the content in-between the second section starting point and the second section ending point as a second to-be-compared section, wherein the first section starting point is set up at the start of the first to-be-compared file 201, and the second section starting point is set up at the start of the second to-be-compared file (step S2). The processing unit 22 compares the words in the first to-be-compared section with the words in the second to-be-compared section in a one-to-one manner, and generates a section comparison result (step S3). The processing unit 22 resets the first section starting point, the first section ending point, the second section starting point and the second section ending point, and reads the content in-between the first section starting point and the first section ending point as a first to-be-compared section, and reads the content in-between the second section starting point and the second section ending point as a second to-be-compared section (step S4). The processing unit 22 compares the words in the first to-be-compared section with the words in the second to-be-compared section in a one-to-one manner, and generates a section comparison result again (step S5). The processing unit 22 determines whether the first section ending point is the end of the first to-be-compared file and the second section ending point is the end of the second to-be-compared file (step S6); if yes, the processing unit processes the generated section comparison results to generate the comparison result (step S7), otherwise, returning to step S4.

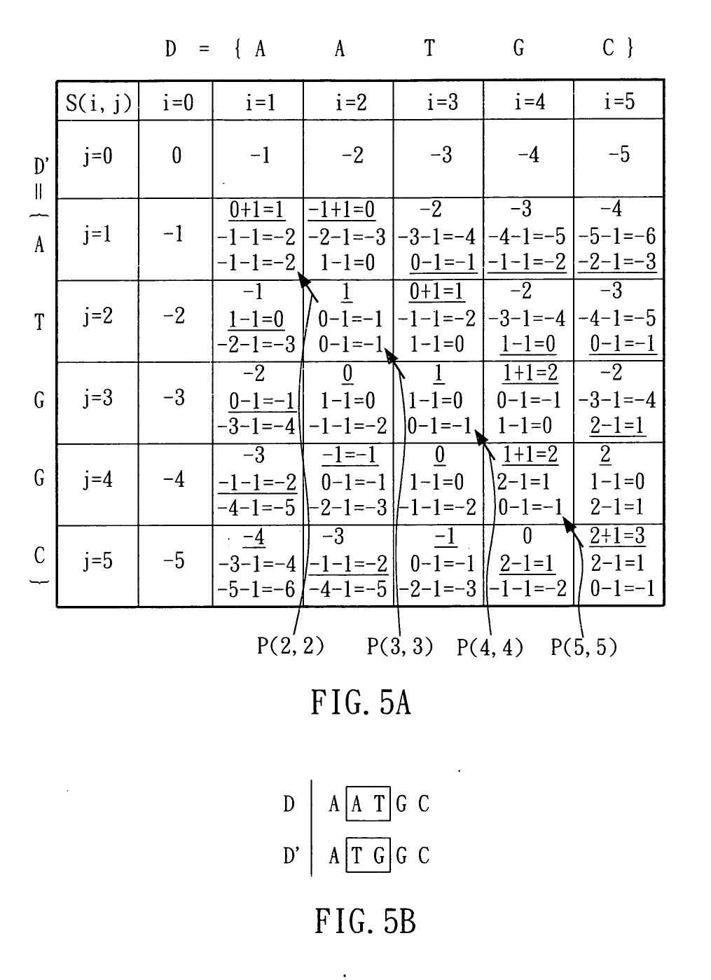

The comparison operation executed for the first to-be-compared section and the second to-be-compared section by the processing unit 22 is preferably to first generate a section score table according to the words in the first to-be-compared section and the second to-be-compared section. Please refer to FIG. 5A, which is a schematic diagram of the section score table according to an embodiment of the present invention. As shown in FIG. 5A, the first to-be-compared section D is AATGC, and the second to-be-compared section D′ is ATGGC. The processing unit 22 compares the words in the first to-be-compared section D with the words in the second to-be-compared section D′ in a one-to-one manner, and fills comparison results in the section score table.

In this embodiment, the processing unit 22 compares the words in the first to-be-compared section D with the words in the second to-be-compared section D′ in a one-to-one manner according to the following equation for providing the comparison result of the shortest path:

$$S ( i , 0 ) = 0 - i , \\ S ( 0 , j ) = 0 - j , \\ S ( i , j ) = Max \{ \begin{matrix}S ( i - 1 , j - 1 ) + 1 & if D ( i ) = {D}^{′} ( j ) \\ S ( i - 1 , j - 1 ) & if D ( i ) \neq {D}^{′} ( j ) \\ S ( i , j - 1 ) - 1 & \\ S ( i - 1 , j ) - 1 & \end{matrix} , \\ i = 1 , 2 , 3 , … \\ j = 1 , 2 , 3 …$$

where i is the ordinal number of the words in the first to-be-compared section, j is the ordinal number of the words in the second to-be-compared section, S(i, j) is the numbers, D(i) and D′(j) are the contents of the first to-be-compared section D and the second to-be-compared section D′ respectively, and the source direction indexes are one-to-one mapping to the numbers to record a source direction of the numbers S(i, j).

First, S(1, 1) is calculated by substituting i=1 and j=1 into the

$$S ( 1 , 1 ) = Max \{ \begin{matrix}S ( 0 , 0 ) + 1 & if D ( 1 ) = {D}^{′} ( 1 ) \\ S ( 0 , 0 ) & if D ( 1 ) \neq {D}^{′} ( 1 ) \\ S ( 1 , 0 ) - 1 & \\ S ( 0 , 1 ) - 1 & \end{matrix} ,$$

where D(1)=A, D′(1)=A, i.e. D(1)=D′(1).

$$⇒ S ( 1 , 1 ) = Max \{ \begin{matrix}0 + 1 = 1 \\ - 1 - 1 = - 2 \\ - 1 - 1 = - 2\end{matrix} \\ ⇒ S ( 1 , 1 ) = 1$$

Therefore, S(1, 1) is calculated as 1.

Next, S(1, 2) is calculated by substituting i=1 and j=2 into the above equation:

$$S ( 1 , 2 ) = Max \{ \begin{matrix}S ( 0 , 1 ) + 1 & if D ( 1 ) = {D}^{′} ( 2 ) \\ S ( 0 , 1 ) & if D ( 1 ) \neq {D}^{′} ( 2 ) \\ S ( 1 , 1 ) - 1 & \\ S ( 0 , 2 ) - 1 & \end{matrix} ,$$

where D(1)=A, D′(2)=T, i.e. D(1)≠D′(2).

$$⇒ S ( 1 , 2 ) = Max \{ \begin{matrix}- 1 \\ 1 - 1 = 0 \\ - 2 - 1 = - 3\end{matrix} \\ ⇒ S ( 1 , 2 ) = 0$$

Thus, S(1, 2) is calculated as 1.

In the operation process of the section score table, the processing unit 22 preferably compares each word D(i) in the first to-be-compared section with each word D′(j) in the second to-be-compared section, then uses a flag array to record whether they are the same or not, and calculates all of the S(i, j) according to the flag array.

The processing unit 22 calculates the values of S(1, 1) to S(5, 5) respectively according to the above operation process and stores them to a number array. The processing unit 22 simultaneously determines the corresponding direction index P(i, j) according to the calculated values of S(i, j) during the operation process, and stores the direction indexes P(i, j) to a direction array. For example, S(1, 2)=0 is calculated from the value of S(1, 1) according to the equation and the above operation process, thus, the corresponding direction index P(1, 2) points to S(1, 1).

Next, the processing unit 22 generates a section comparison result according to the calculated S(i, j) and the corresponding direction index P(i, j). The section comparison result is a section backtracking path, which backtracks from the lower right corner of the section score table; i.e., P(5, 5) points to S(4, 4), P(4, 4) points to S(3, 3), P(3, 3) points to S(2, 2), and P(2, 2) points to S(1, 1), so that the section backtracking path of the comparison operation can be obtained. With reference to FIG. 5B, which is a schematic diagram of the comparison result of the section score table according to an embodiment of the present invention. As shown in FIG. 5B, the differences of the first to-be-compared section D and the second to-be-compared section D′ are directly marked in the comparison result of this embodiment.

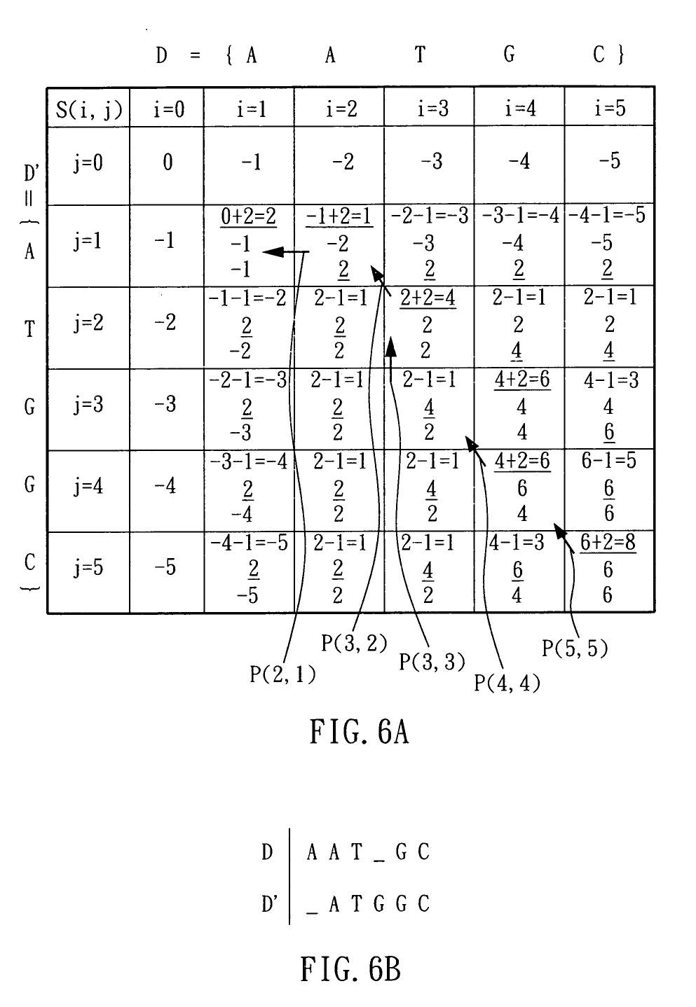

Please refer to FIG. 6A, which is a schematic diagram of the section score table according to another embodiment of the present invention. The processing unit 22 executes comparison operation for the first to-be-compared section D and the second to-be-compared section D′ according to the following equation for providing the comparison result of the best insertion:

$$S ( i , 0 ) = 0 - i , \\ S ( 0 , j ) = 0 - j , \\ S ( i , j ) = Max \{ \begin{matrix}S ( i - 1 , j - 1 ) + 2 & if D ( i ) = {D}^{′} ( j ) \\ S ( i - 1 , j - 1 ) - 1 & if D ( i ) \neq {D}^{′} ( j ) \\ S ( i , j - 1 ) & \\ S ( i - 1 , j ) & \end{matrix} , \\ i = 1 , 2 , 3 , … \\ j = 1 , 2 , 3 …$$

The processing unit 22 calculates the values of S(1, 1) to S(5, 5), determines the direction indexes P(1, 1) to P(5, 5) according to the calculated values, generates the backtracking path and obtains the comparison result. With reference to FIG. 6B, which is a schematic diagram of the comparison result of the section score table according to another embodiment of the present invention. As shown in FIG. 6B, the word insertion points in the first to-be-compared section D and the second to-be-compared section D′ are marked in the comparison result of this embodiment.

The comparison method according to the present invention respectively cuts two to-be-compared files into multiple to-be-compared sections and compares the sections in a one-to-one manner. Thus, the comparison speed does not decrease quickly with the increasing of the file size. However, the file connection between the cut to-be-compared sections may cause discontinuity in the section comparison result, and thus reduce the comparison accuracy. Therefore, the comparison method of the present invention performs a determination on the comparison result for adjusting the position of the section starting point when resetting the to-be-compared section, so as to avoid comparison accuracy reduction caused by discontinuity.

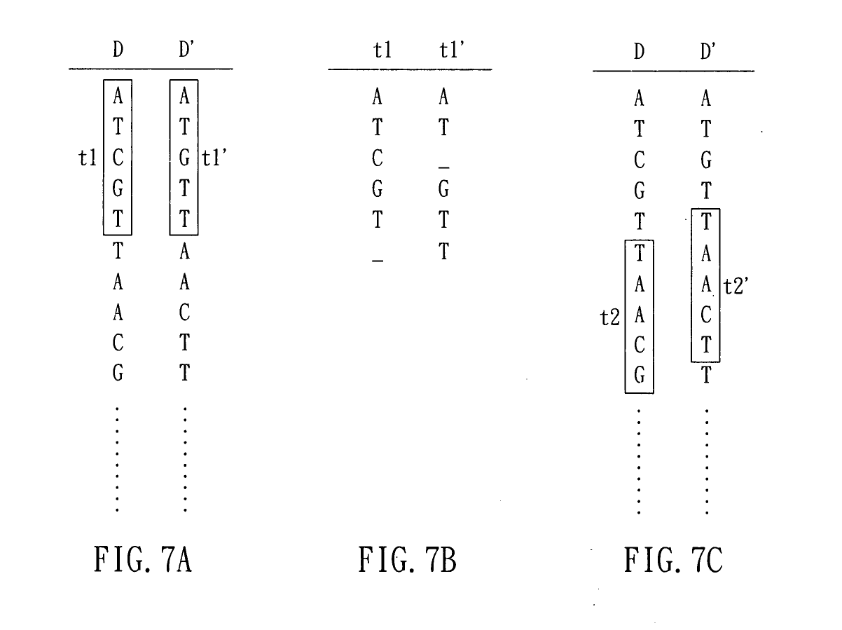

With reference to FIGS. 7A to 7C, FIG. 7A is a schematic diagram of setting up the to-be-compared sections in the two to-be-compared files according to an embodiment of the present invention, FIG. 7B is a schematic diagram of the comparison result of the two to-be-compared sections according to an embodiment of the present invention, and FIG. 7C is a schematic diagram of resetting the to-be-compared sections in the two to-be-compared files according to an embodiment of the present invention. As shown in FIG. 7A, the processing unit 22 sets up the first to-be-compared section t1 in the first to-be-compared file D, and sets up the second to-be-compared section t1′ in the second to-be-compared file D′, wherein the first section starting point is the start of the first to-be-compared file D, and the second section starting point is the start of the second to-be-compared file D′. The processing unit 22 compares the words in the first to-be-compared section t1 with the words in the second to-be-compared section t1′ in a one-to-one manner, so as to generate a section comparison result. FIG. 7B shows the comparison result of using the best insertion method to perform comparison operation on the first to-be-compared section t1 and the second to-be-compared section t1′ by the processing unit 22, wherein the first to-be-compared section t1 has a terminal inserting part. The processing unit 22 performs a determination according to the section comparison result in FIG. 7B when resetting the first to-be-compared section t2 and the second to-be-compared section t2′, and sets up the second section starting point of the reset second to-be-compared section t2′ in front of the terminal inserting part of the first to-be-compared section t1, as shown in FIG. 7C, and the processing unit 22 performs a comparison operation on the first to-be-compared section t2 and the second to-be-compared section t2′.

The comparison method of the present invention is provided for quickly and effectively performing comparison on two text files with large file size, which respectively cuts two to-be-compared files into multiple to-be-compared sections and compares the words in them sequentially; hence, the comparison speed does not decrease quickly with increasing of the file size. In addition, the comparison method of the present invention performs a determination on the comparison result, so as to adjust the position of the section starting point of the reset to-be-compared section, so as to avoid comparison accuracy reduction caused by discontinuity.

Since the differences between two different test pattern files can be quickly marked, performing comparison operation of the present invention is really helpful for wafer manufacturers to control files, such as the test pattern files with different versions.

In addition, when performing comparison operation of the present invention, users can choose to use the method of the shortest path or the best insertion according to comparison conditions, such as file property and comparison purpose, and users can also adjust required comparison accuracy and choose performing a global comparison or a difference comparison.

Although the present invention has been explained in relation to its preferred embodiment, it is to be understood that many other possible modifications and variations can be made without departing from the spirit and scope of the invention as hereinafter claimed.

What is claimed is:

1. A comparison device for comparing test pattern files of a wafer tester, which is provided for comparing a first to-be-compared file with a second to-be-compared file, wherein the first to-be-compared file and the second to-be-compared file are text files, the comparison device comprising:
a storage unit for storing the first to-be-compared file and the second to-be-compared file; and
a processing unit for processing and executing comparison operation for the first to-be-compared file and the second to-be-compared file to generate a comparison result, the comparison operation comparing words in a first section of the first to-be-compared file with words in a second section of the second to-be-compared file in a one-to-one manner,
wherein the first to-be-compared file and the second to-be-compared file are input into the comparison device; the comparison device stores the first to-be-compared file and the second to-be-compared file into the storage unit; the processing unit reads the first to-be-compared file and the second to-be-compared file from the storage unit, processes and executes comparison operation, and generates the comparison result.

2. The comparison device as claimed in claim 1, wherein the processing unit is provided for setting up a first section starting point and a first section ending point in the first to-be-compared file in order to read content in-between the first section starting point and the first section ending point as a first to-be-compared section, setting up a second section starting point and a second section ending point in the second to-be-compared file in order to read content in-between the second section starting point and the second section ending point as a second to-be-compared section, executing the comparison operation to compare words in the first to-be-compared section with words in the second to-be-compared section in a one-to-one manner, and generating the comparison result.

3. The comparison device as claimed in claim 1, wherein the first section starting point is a start of the first to-be-compared file, and the second section starting point is a start of the second to-be-compared file.

4. The comparison device as claimed in claim 2, wherein the comparison operation executed for the first to-be-compared section and the second to-be-compared section is to generate a section score table according to the words in the first to-be-compared section and the second to-be-compared section first, execute comparison operation respectively and fill the comparison result in the section score table, and the processing unit builds up a section comparison result, which is a section backtracking path.

5. The comparison device as claimed in claim 2 wherein the processing unit further performs a determination on the section comparison result and, if it is determined that the first section ending point is an end of the first to-be-compared file and the second section ending point is an end of the second to-be-compared file, the processing unit processes the generated section comparison result to generate the comparison result.

6. The comparison device as claimed in claim 5, wherein, if it is determined that the first section ending point is not the end of the first to-be-compared file or the second section ending point is not the end of the second to-be-compared file, the processing unit resets the first section starting point, the first section ending point, the second starting point and the second section ending point, reads the words in-between the first section starting point and the first section ending point as the first to-be-compared section, reads the words in-between the second section starting point and the second section ending point as the second to-be-compared section, executes, comparison operation for the words in the first to-be-compared section and the second to-be-compared section and generate a section comparison result.

7. The comparison device as claimed in claim 6, wherein locations of the first section starting point and the second section starting point are determined by the processing unit according to the section comparison result and, if it is determined that the first to-be compared section or the second to-be-compared section has a terminal inserting part, a reset location of the first section starting point or the second section starting point is in front of the terminal inserting part.

8. The comparison device as claimed in claim 1, wherein the first to-be-compared file and the second to-be-compared file each have a file size greater than 1 GB.

9. The comparison device as claimed in claim 4, wherein the processing unit performs comparison operation for the first to-be-compared section and the second to-be-compared section according to an equation, and the comparison result is stored as a number array and a direction array based on which the section backtracking path is generated, and wherein the number array includes multiple numbers, the direction array includes multiple source direction indexes, the equation is used for calculating the numbers, and the source direction indexes are determined from the calculated numbers.

10. The comparison device as claimed in claim 9, wherein the equation is:
$$S ( i , 0 ) = 0 - i , \\ S ( 0 , j ) = 0 - j , \\ S ( i , j ) = Max \{ \begin{matrix}S ( i - 1 , j - 1 ) + 1 & if D ( i ) = {D}^{′} ( j ) \\ S ( i - 1 , j - 1 ) & if D ( i ) \neq {D}^{′} ( j ) \\ S ( i , j - 1 ) - 1 & \\ S ( i - 1 , j ) - 1 & \end{matrix} , \\ i = 1 , 2 , 3 , … \\ j = 1 , 2 , 3 …$$
where i is an ordinal number of the words in the first to-be-compared section, j is an ordinal number of the words in the second to-be-compared section, S(i, j) is the numbers, and D(i) and D′(j) are contents of the first to-be-compared section and the second to-be-compared section respectively; the source direction indexes are one-to-one mapping to the numbers so as to record a source direction of the numbers S(i, j).

11. The comparison device as claimed in claim 9, wherein the equation is:
$$S ( i , 0 ) = 0 - i , \\ S ( 0 , j ) = 0 - j , \\ S ( i , j ) = Max \{ \begin{matrix}S ( i - 1 , j - 1 ) + 2 & if D ( i ) = {D}^{′} ( j ) \\ S ( i - 1 , j - 1 ) - 1 & if D ( i ) \neq {D}^{′} ( j ) \\ S ( i , j - 1 ) & \\ S ( i - 1 , j ) & \end{matrix} , \\ i = 1 , 2 , 3 , … \\ j = 1 , 2 , 3 … ,$$
where i is an ordinal number of the words in the first to-be-compared section, j is an ordinal number of the words in the second to-be-compared section, S(i, j) is the numbers, and D(i) and D′(j) are contents of the first to-be-compared section and the second to-be-compared section respectively; the source direction indexes are one-to-one mapping to the numbers to record a source direction of the numbers S(i, j).

12. The comparison device as claimed in claim 9, wherein a flag array is provided for recording whether the words in the first to-be-compared section and the second to-be-compared section are the same or not for allowing the processing unit to execute operation.

13. A comparison method for comparing test pattern files of a wafer tester, which is used for comparing a first to-be-compared file with a second to-be-compared file by a computer device, the first to-be-compared file and the second to-be-compared file being text files, the computer device including a storage unit for storing files and a processing unit for processing and executing comparison operation to generate a comparison result, the comparison operation being to compare words in a first section of the first to-be-compared file with words in a second section of the second to-be-compared file, the comparison method comprising the steps of:
(A) inputting the first to-be-compared file and the second to-be-compared file into the comparison device;
(B) the comparison device storing the first to-be-compared file and the second to-be-compared file into the storage unit; and
(C) the processing unit reading the first to-be-compared file and the second to-be-compared file from the storage unit, processing and executing comparison operation, and generating the comparison result.

14. The comparison method as claimed in claim 13, wherein step (C) comprises the steps of:
(C1) the processing unit setting up a first section starting point and a first section ending point in the first to-be-compared file, and setting up a second section starting point and a second section ending point in the second to-be-compared file, wherein the first section starting point is a start of the first to-be-compared file, and the second section starting point is a starta of the second to-be-compared file;
(C2) the processing unit reading content in-between the first section starting point and the first section ending point as a first to-be-compared section, and reading content in-between the second section starting point and the second section ending point as a second to-be-compared section;
(C3) the processing unit comparing the words in the first to-be-compared section with the words in the second to-be-compared section, and generating a section comparison result;
(C4) the processing unit resetting the first section starting point and the first section ending point in the first to-be-compared file, and resetting the second section starting point and the second section ending point in the second to-be-compared file;
(C5) the processing unit reading content in-between the first section starting point and the first section ending point as a first to-be-compared section, and reading content in-between the second section starting point and the second section ending point as a second to-be-compared section;
(C6) the processing unit comparing the words in the first to-be-compared section with the words in the second to-be-compared section, and generating a section comparison result; and
(C7) the processing unit determining whether the first section ending point is an end of the first to-be-compared file and the second section ending point is an end of the second to-be-compared file and, if yes, the processing unit processing the generated section comparison result to generate the comparison result, otherwise returning to step (C4).

15. The comparison method as claimed in claim 14, wherein step (C3) further comprises the step of:
the processing unit generating a section score table according to the words in the first to-be-compared section and the second to-be-compared section, executing comparison operation respectively and filling comparison result in the section score table, and building up a section comparison result, which is a section backtracking path.

16. The comparison method as claimed in claim 14, wherein in step (C4), locations of the first section starting point and the second section starting point are determined by the processing unit according to the section comparison result and, if it is determined that the first to-be-compared section or the second to-be-compared section has a terminal inserting part, a reset location of the first section starting point or the second section starting point is in front of the terminal inserting part.
